(19) United States
(12) Patent Application Publication
(10) Pub. No.: US 2024/0250871 A1
(43) Pub. Date: Jul. 25, 2024

(54) DEPLOYING A NETWORK DEVICE IN A COMMUNICATION NETWORK OPERATED BY A NETWORK OPERATOR

(71) Applicant: Elisa Oyj, Helsinki (FI)

(72) Inventors: Reko KAUPPINEN, Helsinki (FI); Joni NUVOLA, Helsinki (FI); Pasi SIKALA, Helsinki (FI); Heimo NIININEN, Helsinki (FI)

(21) Appl. No.: 18/564,633

(22) PCT Filed: Jun. 8, 2022
(86) PCT No.: PCT/FI2022/050395

§ 371 Date: Nov. 28, 2023

(30) Foreign Application Priority Data
Jun. 14, 2021 (FI) 20215693

(51) Int. Cl. H04L 41/0806; G06F 9/445

(52) U.S. Cl. CPC H04L 41/0806; G06F 9/44505

(57) ABSTRACT

A computer implemented method for configuring a network device of a communications network operated by a network operator. The method comprises obtaining network device configuration data from a support system of the network operator, performing a configuration process to configure the network device in an event-based manner, and providing the support system with updated information of the communications network indicating a success of said configuration process.

### TECHNICAL FIELD

The present disclosure generally relates to configuring a network device of a communication network. The disclosure relates particularly, though not exclusively, to a method for configuring a network device by zero touch provisioning.

### BACKGROUND

This section illustrates useful background information without admission of any technique described herein representative of the state of the art.

The number of deployments of network devices in communication networks operated by network operators has increased rapidly, inter alia, due to more dense base station infrastructure in mobile communication networks. The traditional approach of configuring new devices requires lots of manual work, which is prone to errors.

Zero touch provisioning is a method that automates the process of configuring a new device into a network. It reduces or removes manual tasks in configuring the devices.

### SUMMARY

It is an object of certain embodiments of the invention to provide an improved process to deploy a network device in a communication network or at least to provide an alternative solution to existing technology.

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect of the present invention, there is provided a computer implemented method for configuring a network device of a communications network operated by a network operator, the method comprising: obtaining network device configuration data (or input parameters) from a support system of the network operator;
performing a configuration process to configure the network device in an event-based manner; and
providing the support system with updated information of the communications network indicating a success of said configuration process.

In certain embodiments, the support system is a support system of a network operator of a cellular communications network. In certain embodiments, the support system is an operations support system (OSS).

In certain embodiments, said performing a configuration process comprises performing zero touch provisioning, ZTP, and using events. Accordingly, in certain embodiments, the network device is a ZTP enabled device.

In certain embodiments, said performing a configuration process comprises applying software components of a microservice architecture and using events.

By using events, information is obtained about the status of the configuration process, and when the process is completed. Events are used to trigger and communicate between the microservices (or the software components of the microservice architecture). Herein, an event means for example a change in state, or an update.

In certain embodiments, the method comprises the software components together forming a microservices application, and the software components communicating with the aid of a message broker.

In certain embodiments, the method comprises keeping track of progress of the configuration process (through the use of the events).

In certain embodiments, the method comprises providing a rollback ability of the configuration process (through the use of the events).

In certain embodiments, the method comprises:
providing the network element with a temporary connectivity for loading configuration data (or software) from a file server.

In certain embodiments, said loading configuration data comprises loading a configuration file. In certain embodiments, said loading configuration data comprises loading a configuration file or files, and/or device software (or software image).

In certain embodiments, said providing the network element with a temporary connectivity comprises configuring neighbor devices to provide the network element with connectivity.

In certain embodiments, said providing the network element with a temporary connectivity comprises obtaining an IP address for said network device. In certain embodiments, the method comprises obtaining an IP address dynamically.

In certain embodiments, the method comprises:
the file server providing a zero touch service software component with status information of said loading of the configuration data (or software).

In certain embodiments, the method comprises:
cleaning up the temporary connectivity, and finalizing the configuration process thereafter.

In certain embodiments, the method comprises:
verifying the status of the network device after cleaning up the temporary connectivity.

In certain embodiments, said verifying the status comprises inquiring from said network device whether the network device is up and running, and optionally, whether the necessary setup steps have been performed.

In certain embodiments, the method comprises performing network level configuration of the network element (of the ISO OSI model).

In certain embodiments, the network device is a router. In certain embodiments, the network device is a network switch, a wireless access points, or a firewall.

In certain embodiments, the method comprises providing a vendor-independent upper-level workflow for configuring a network device. In certain embodiments, said upper level refers to a level on top of the network level (or higher than the network level) in a used protocol stack (e.g. the protocol stack according to the ISO OSI model).

According to a second example aspect of the present invention, there is provided an apparatus, comprising:
a processor; and
a memory including computer program code, the memory and the computer program code being configured, with the processor, to cause the apparatus to perform the method of the first aspect or any related embodiment.

In certain embodiments, the apparatus comprises a file server comprising configuration data (or software) for the network device, and the file server being configured to provide a zero touch service software component with status information on loading of the configuration data (or software) to the network device.

According to a third example aspect of the present invention, there is provided a computer program comprising computer executable program code which when executed by a processor causes an apparatus to perform the method of the first aspect or any related embodiment.

According to a fourth example aspect there is provided a computer program product comprising a non-transitory computer readable medium having the computer program of the third example aspect stored thereon.

According to a fifth example aspect there is provided an apparatus comprising means for performing the method of the first aspect or any related embodiment.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments apply to other example aspects as well.

### BRIEF DESCRIPTION OF THE FIGURES

Some example embodiments will be described with reference to the accompanying figures, in which:

FIG. 1 schematically shows a scenario according to an example embodiment;

FIG. 2 shows a block diagram of an apparatus according to an example embodiment;

FIG. 3 shows a flow chart according to an example embodiment; and

FIG. 4 shows a flow chart according to another example embodiment.

### DETAILED DESCRIPTION

In the following description, like reference signs denote like elements or steps.

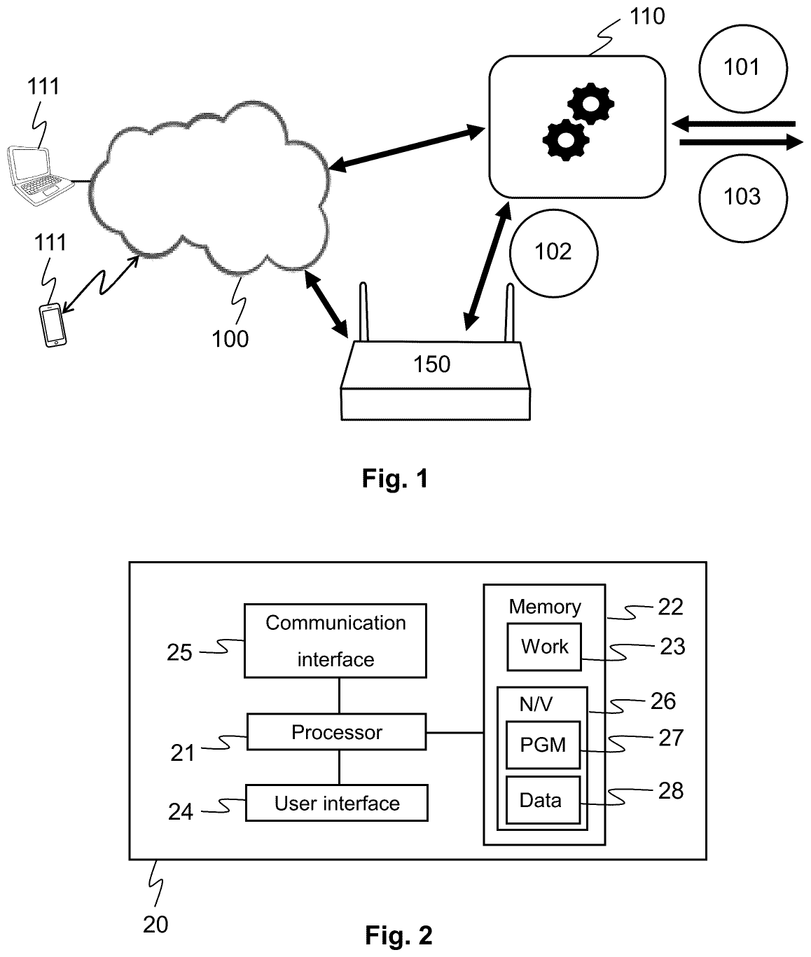

FIG. 1 shows an example scenario according to an embodiment. The scenario shows a communication network 100 operated by a network operator. In certain embodiments, the network 100 servs a plurality of user devices 111 (user equipment, UE). In certain embodiments, the user devices 111 have fixed and/or wireless connections to the network 100. In certain embodiments, the network 100 comprises a plurality of cells and base station sites. In other embodiments, the network is a computer network. In certain embodiments, the network 100 is an IP network. In other embodiments, on the other hand, the network 100 is not an access network. In certain embodiments, the network 100 is an enterprise data network.

The scenario further shows an automated system configured to perform configuration processes of new network devices 150 added into the network 100.

In an embodiment, the scenario of FIG. 1 operates as follows: In phase 101, the automated system 110 obtains, from a support system, such as an operations and support system (OSS), information of a need to configure the new network device 150. In phase 102, the automated system 110 performs a configuration process. And, in phase 103, updated information of the network 100 which now has the added new network device 150 is provided to the support system.

FIG. 2 shows a block diagram of an apparatus 20 according to an embodiment. The apparatus 20 is for example a general-purpose computer or server or some other electronic data processing apparatus. In certain embodiments, the apparatus 20 is an apparatus that supports or implements a distributed architecture, in particular a microservice architecture. The apparatus 20 can be used for implementing at least some embodiments of the invention. That is, with suitable configuration the apparatus 20 is suited for operating for example as the automated system 110.

The apparatus 20 comprises a communication interface 25, a processor 21, a user interface 24, and a memory 22.

The communication interface 25 comprises in an embodiment a wired and/or wireless communication circuitry, such as Ethernet, Wireless LAN, Bluetooth, GSM, CDMA, WCDMA, LTE, and/or 5G circuitry. The communication interface can be integrated in the apparatus 20 or provided as a part of an adapter, card or the like, that is attachable to the apparatus 20. The communication interface 25 may support one or more different communication technologies. The apparatus 20 may also or alternatively comprise more than one communication interface 25.

The processor 21 may be a central processing unit (CPU), a microprocessor, a digital signal processor (DSP), a graphics processing unit, an application specific integrated circuit (ASIC), a field programmable gate array, a microcontroller or a combination of such elements.

The user interface 24 may comprise a circuitry for receiving input from a user of the apparatus 20, e.g., via a keyboard, graphical user interface shown on the display of the apparatus 20, speech recognition circuitry, or an accessory device, such as a headset, and for providing output to the user via, e.g., a graphical user interface or a loudspeaker.

The memory 22 comprises a work memory 23 and a persistent (non-volatile, N/V) memory 26 configured to store computer program code 27 and data 28. The program code, in certain embodiments, comprises software components to implement microservices of the microservice architecture. In certain embodiments, the computer program code further comprises a message broker software module to implement messaging between the microservices. The memory 26 may comprise any one or more of: a read-only memory (ROM), a programmable read-only memory (PROM), an erasable programmable read-only memory (EPROM), a random-access memory (RAM), a flash memory, a data disk, an optical storage, a magnetic storage, a smart card, a solid state drive (SSD), or the like.

The apparatus 20 may comprise a plurality of memories 26. The memory 26 may be constructed as a part of the apparatus 20 or as an attachment to be inserted into a slot, port, or the like of the apparatus 20 by a user or by another person or by a robot. The memory 26 may serve the sole purpose of storing data, or be constructed as a part of an apparatus 20 serving other purposes, such as processing data.

A skilled person appreciates that in addition to the elements shown in FIG. 2, the apparatus 20 may comprise other elements, such as microphones, displays, as well as additional circuitry such as an input/output (I/O) circuitry, memory chips, application-specific integrated circuits (ASIC), a processing circuitry for specific purposes such as a source coding/decoding circuitry, a channel coding/decoding circuitry, a ciphering/deciphering circuitry, and the like. Additionally, the apparatus 20 may comprise a disposable or rechargeable battery (not shown) for powering the apparatus 20 when external power if external power supply is not available.

Further, it is noted that only one apparatus is shown in FIG. 2, but the embodiments of the invention may equally be implemented in a cluster of shown apparatuses.

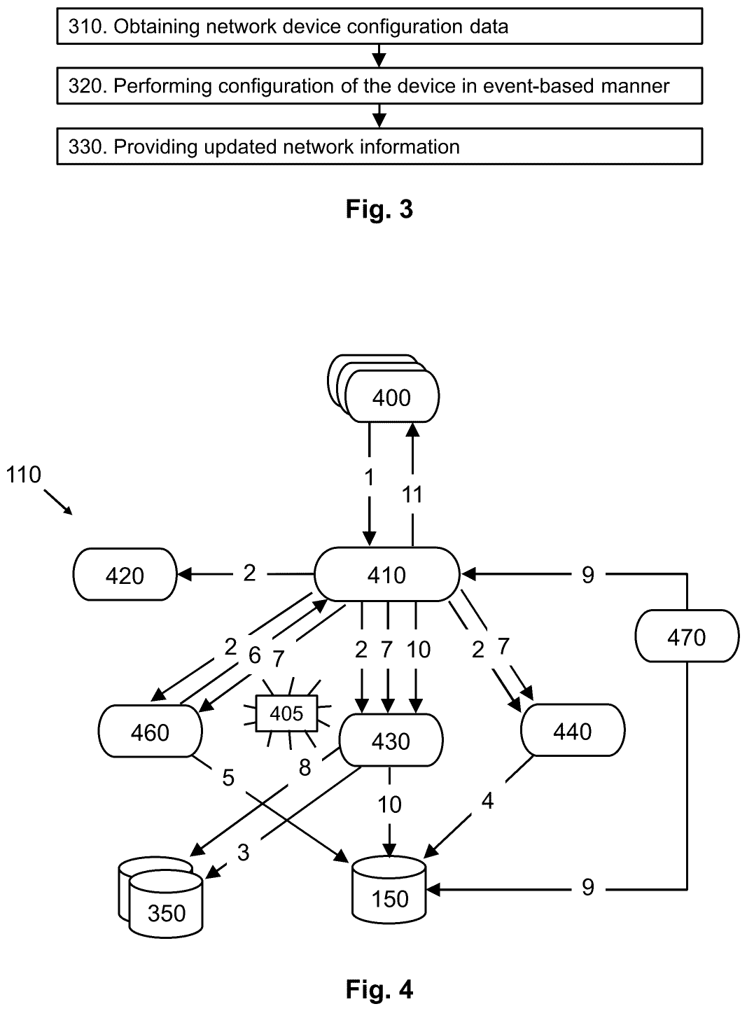

FIG. 3 shows a flow chart according to an example embodiment. In phase 310, configuration data (or input parameters) of the new network device 150 is obtained from a support system of the network operator. The configuration data (or input parameters) of phase 310 in certain embodiments comprises initial information that triggers an actual event-based configuration (or deployment) process. In phase 320, a configuration (or deployment) process is performed to configure the network device 150 in an event-based manner. And, in phase 330, the support system is provided with updated information of the communications network indicating a success of said configuration process.

FIG. 4 shows a flow chart of a more detailed embodiment. The network operator, which may be for example a cellular network operator, typically comprises support systems 400, such as an operations support system (OSS). When a new network device, such as a router 150, is to be added into the network 100 (see FIG. 1) information of a need to configure the new network device 150 is sent to the automated system 110 that carries out the configuration process. In this embodiment, the automated system 110 is implemented by a microservice architecture comprising software components that communicate with the aid of a message broker 405. The software components in an embodiment comprise a zero touch service software component 410, a template engine 420, and a provisioner 430. In addition, a DHCP (Dynamic Host Configuration Protocol) server module 440 (or in another embodiment, a TFTP (Trivial File Transfer Protocol) server module), and a file server module 460 are implemented. The microservice architecture further comprises a verification component 470.

In the embodiment shown in FIG. 4, the new network device 150 is a ZTP-enabled device. A zero touch provisioning process (configuration process) is performed in phases (or steps) 1-11 as follows. The process is carried out with the aid of the microservice architecture and using events. Carrying out the process in the event-based manner enables on one hand following the steps of the configuration process and on the other hand clean rollback from step to step (if required).

In phase 1, the zero touch service 410 receives (initial) configuration data (or input parameters) from the support system 400 of the network operator. In a component preparation phase 2, the zero touch service 410 obtains from the template engine a more detailed set of configuration parameters. Based on this data, the zero touch service 410 communicates data to the provisioner 430, DHCP server 440 and the file server 460 to prepare for the network device 150 to wake up. In phase 3, the provisioner 430 configures neighboring network device(s) 350 (e.g., neighbor router(s)) by sending settings to create temporary connectivity for the new network device 150. Once the new network device 150 is powered on it runs a boot sequence and requests from the DHCP server 440 connectivity data including an IP address.

In phase 4, the DHCP server 440 send the IP address and location information of (actual) configuration data (or configuration software). In phase 5, the new network device 150 downloads this configuration data from the file server 460. In an embodiment, this configuration data comprises a configuration file or files. In certain embodiment, the configuration data comprises device software (image). The new network device 150 then installs the configuration data. In phase 6, the file server component 460 communicates to the zero touch service component 410 that the transfer of configuration data is completed. Accordingly, phase 6 represents an example of providing the zero touch service component 410 with event-based information. In phases 7 and 8, data and/or settings from phases 2 and 3, which have become redundant in view of the progress of the configuration process, is removed (component clean up). In particular, the temporary connectivity created in phase 3 is removed by re-configuring the neighboring network device(s) 350. In phase 9, the verification software component 470 inquires from the new network device 150 whether the network device 150 is up and running, and optionally, whether the necessary setup steps have been performed. The verification component 470 informs the zero touch service component 410 about a response received to the inquiry. Depending on the model of the new network device 150, as a further event-based step, a further software update is performed in phase 10. In an embodiment, the zero touch service component 410 controls that the software update is loaded to a local memory of the new network device 150, e.g., a flash disc or similar, for installing.

Once the configuration process is completed the zero touch service component 410 provides the support system 400 with updated information of the communications network 100 in phase 11. The updated information indicates presence of the new network device 150 in the network (therefore at least indirectly indicating a success of said configuration process).

The embodiment shown in FIG. 4 represents an example of an event-based configuration process. In other embodiments, a configuration process containing different or modified phases may be implemented.

Without limiting the scope and interpretation of the patent claims, certain technical effects of one or more of the example embodiments disclosed herein are listed in the following. A technical effect is providing a real end-to-end zero touch provisioning at an OSS level for multivendor environments. Another technical effect is providing an identical upper level workflow that is independent of a used system and vendor. Another technical effect is providing a clean rollback in case of a failure. Various embodiments have been presented. It should be appreciated that in this document, words comprise, include and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A computer implemented method for configuring a network device of a communications network operated by a network operator, the method comprising:
obtaining network device configuration data from a support system of the network operator;
performing a configuration process to configure the network device in an event-based manner; and
providing the support system with updated information of the communications network indicating a success of said configuration process.

2. The method of claim 1, wherein said performing a configuration process comprises performing zero touch provisioning, ZTP, and using events.

3. The method of claim 1, wherein said performing a configuration process comprises applying software components of a microservice architecture and using events.

4. The method of claim 3, comprising the software components forming a microservices application, and the software components communicating with the aid of a message broker.

5. The method of claim 3, comprising keeping track of progress of the configuration process.

6. The method of claim 5, comprising providing a rollback ability of the configuration process.

7. The method of claim 1, comprising:
providing the network element with a temporary connectivity for loading configuration data from a file server.

8. The method of claim 7, comprising:
the file server providing a zero touch service software component with status information of said loading of the configuration data.

9. The method of claim 8, comprising:
cleaning up the temporary connectivity, and finalizing the configuration process thereafter.

10. The method of claim 9, comprising:
verifying the status of the network device after cleaning up the temporary connectivity.

11. The method of claim 1, comprising performing network level configuration of the network element.

12. The method of claim 1, wherein the network device is a router.

13. An apparatus, comprising:
at least one processor; and
at least one memory including computer program code, the at least one memory and the computer program code being configured, with the at least one processor, to cause the apparatus to perform the method claim 1.

14. The apparatus of claim 13, comprising a file server comprising configuration data for the network device, and the file server being configured to provide a zero touch service software component with status information on loading of the configuration data to the network device.

15. A computer program comprising computer executable program code which when executed by at least one processor causes an apparatus to perform the method of claim 1.

16. The method of claim 2, wherein said performing a configuration process comprises applying software components of a microservice architecture and using events.

17. The method of claim 16, comprising the software components forming a microservices application, and the software components communicating with the aid of a message broker.

18. The method of claim 17, comprising keeping track of progress of the configuration process.

19. The method of claim 18, comprising providing a rollback ability of the configuration process.

20. The method of claim 2, comprising:
providing the network element with a temporary connectivity for loading configuration data from a file server.
